(19) United States
(12) Patent Application Publication
(10) Pub. No.: US 2007/0077408 A1
(43) Pub. Date: Apr. 5, 2007

(54) Cleaning sheet and method of producing same

(75) Inventors: Hiromitsu Okuyama, Tokyo (JP); Mitsuru Saito, Tokyo (JP); Jun Tamura, Tokyo (JP)

Correspondence Address: BEYER WEAVER LLP, P.O. BOX 70250, OAKLAND, CA, 94612-0250, US

(73) Assignee: NIHON Micro Coating Co., Ltd.

(21) Appl. No.: 11/542,969

(22) Filed: Oct. 3, 2006

(30) Foreign Application Priority Data
Oct. 4, 2005 (JP) 2005-291234

(51) Int. Cl. B32B 3/26

(52) U.S. Cl. 428/304.4

(57) ABSTRACT

A cleaning sheet has a foamed layer on the surface of a plastic base sheet with the thickness in the range of 25 μm or more and 125 μm or less. The foamed layer has average diameter of air bubbles in the range of 1 μm or more and 50 μm or less and preferably 30 μm or less, compressibility in the range of 3% or more and 7% or less, compression recovery ratio in the range of 40% or more and 60% or less, and the Shore D hardness in the range of 20 degrees or more and 30 degrees or less.

This application claims priority on Japanese Patent Application 2005-291234 filed Oct. 4, 2005.

### BACKGROUND OF THE INVENTION

This invention relates to a cleaning sheet of the type for removing unwanted protrusions and scratches formed on the surface of a workpiece such as a magnetic hard disk, a magnetic head, a semiconductor wafer, a liquid crystal panel or an optical lens, as well as foreign objects or a dirty substance such as oil sticking to the surface of a workpiece. This invention also relates to a method of producing such a sheet. More particularly, this invention relates to a sheet suited for use, after the surface of a workpiece has been processed, for removing unwanted protrusions, burrs, scratches, foreign objects and dirt remaining on such a processed surface, trimming and cleaning such a surface to finish it at a high rate of precision, as well as a method of producing such a sheet.

Characteristics of higher levels are always in demand (such as an increased recording capacity for sound and image data and flatness and smoothness for a liquid crystal panel or a camera lens) for apparatus such as computers, televisions, cameras and telephone sets. For obtaining characteristics intended at the time of designing such apparatus, it is essential to produce each of their components exactly according to its design. For example, a magnetic hard disk is widely being used as a medium for recording information. In general, a magnetic hard disk is produced by mirror-polishing the surface of a non-magnetic substrate, carrying out a texturing process on this mirror-polished surface by forming approximately concentric circular marks and sequentially forming a magnetic layer and a protective layer on this textured surface by using a known thin-film technology such as sputtering. After all these processes, the finished surface is cleaned in order to remove foreign objects such as particles, as well as dirty matters such as oil products that are attached thereto.

This cleaning process is usually carried out by supplying a cleaning liquid such as water to the surface of the workpiece such as a magnetic hard disk and rubbing this surface with a tape or a pad made of a sheet of a foamed material, Such a foamed sheet is used because it is a porous body, acts elastically on the surface of the workpiece and is capable of taking in foreign objects from the surface of the workpiece and cleaning it without leaving any scratches thereon.

Very small protrusions (inclusive of foreign objects firmly attached to the surface of the workpiece) which used to be ignored as being within the range of design error, as well as scratches, are now coming to be considered not negligible for the purpose producing apparatus with higher functional characteristics. In the case of a magnetic hard disk, for example, it is necessary to form very fine linear marks with appropriate height and appropriate depth on its surface in the shape of approximately concentric circles, and it is being required to make these protrusions and indentations with a higher level of accuracy and to remove very small protrusions and scratches appearing on the surface.

Since such unwanted protrusions and scratches cannot be removed merely by reducing the hardness of the foamed sheet, it has been proposed (for example, in Japanese Patent Publications Tokkai 2001-9697 and 2001-138249) to use a foamed sheet having abrading particles affixed to a foamed body having low hardness (50 degrees or less in Shore D hardness). Since hard abrading particles contact the surface of the workpiece if such a sheet is used for the cleaning, however, problems of the surface of the workpiece being overly polished to make it rough or scratches being formed are coming to be raised. Moreover, there are also problems of abrading particles dropping off the sheet becoming attached to or stuck to the surface of the workpiece, themselves resulting in becoming unwanted protrusions. In the case of a magnetic hard disk, for example, the fixed abrading particles may excessively polish the line marks already formed on the surface to make it rough or to form scratches and the particles dropped off the sheet may become attached or stuck to the surface to become unwanted protrusions.

In order to avoid such problems that occur with fixed abrading particles, the use of a foamed sheet with higher hardness (in excess of 50 degrees in Shore D hardness) has been examined but such sheets have the problem of not being able to reduce scratches although they can reduce unwanted protrusions and foreign objects.

### SUMMARY OF THE INVENTION

It is therefore an object of this invention in view of the problem described above to provide a cleaning sheet capable of removing unwanted protrusions formed on the surface of a workpiece and foreign objects and the dirt attached to the surface and reducing scratches formed on the surface without overly scraping it, as well as a method of producing such a cleaning sheet.

A cleaning sheet according to this invention comprises a base material formed as a sheet and a foamed layer formed on a surface of this base material. A plastic sheet with the thickness in the range of 25 μm or more and 125 μm or less is used as the base material. The average diameter of air bubbles in this foamed layer is in the range of 1 μm or more and 50 μm or less and preferably 30 μm or less, the compressibility of this foamed layer is in the range of 3% or more and 7% or less, the compression recovery ratio of this foamed layer is in the range of 40% or more and 60% or less, the Shore D hardness of this foamed layer is in the range of 20 degrees or more and 30 degrees or less, and the thickness of this foamed layer is in the range of 50 μm or more and 800 μm or less.

According to a method of this invention for producing a cleaning sheet, a resin solution is mechanically stirred firstly to thereby obtain a paint having dispersed therein air bubbles with average diameter in the range of 1 μm or more and 50 μm or less and preferably 1 μm or more and 30 μm or less and having the expansion ratio in the range of 2× or more and 5× or less.

Preferably, the resin solution contains self-emulsifying waterborne urethane resin. In the above, waterborne urethane resin means waterborne polyurethane dispersion obtained either by introducing a hydrophilic component into the main chain of polyurethane for dispersing stably in water or by dispersing by using an external emulsifier. The former (obtained by directly introducing a hydrophilic component into the skeleton of polyurethane) is called self-emulsifying waterborne polyurethane dispersion. (See, for example, “Recent Development in Technology of Waterborne Polyurethane Dispersion” by Toshifumi Tamaki, Dainippon Ink and Chemicals, Inc.; http://www.six.co.jp/tech/rev0301/index.html.)

The resin solution may further contain an agent that accelerates the foaming of the resin solution and disperses air bubbles stably inside the paint. Such an agent may be selected from the group consisting of higher fatty acids, denaturations of higher aliphatic acids and alkali salts of higher aliphatic acids, and may be higher fatty acid ammonium.

Next, a surface of a base material formed as a sheet is coated with this paint and a membrane comprising this paint is formed on the surface of the base material. Next, this membrane is dried and a foamed layer is formed on the surface of the base material. The average diameter of air bubbles in this foamed layer is in the range of 1 μm or more and 50 μm or less, the compressibility of this foamed layer is in the range of 3% or more and 7% or less, the compression recovery ratio of this foamed layer is in the range of 40% or more and 60% or less, and the Shore D hardness of this foamed layer is in the range of 20 degrees or more and 30 degrees or less.

A cleaning sheet thus produced is cut to a shape which will be easy to use and used as a cleaning tool such as a cleaning tape of a cleaning pad.

With a cleaning sheet of this invention, the surface area portion of the foamed layer (exclusive of the air bubble portions) is large because the average diameter of the air bubbles inside is small, being in the range of 1 μm or more and 50 μm or less and preferably 30 μm or less. Since the compressibility of the foamed layer is in the range of 3% or more and 7% or less, the foamed layer is compressed such that its surface will follow the shape of the surface of the workpiece when the surface of the foamed layer is pressed against the surface of the workpiece. Since the compression recovery ratio of the foamed layer is in the range of 40% or more and 60% or less, the surface of the foamed layer moves on the surface of the workpiece such that the surface of the foamed layer follows the surface of the workpiece as the foamed layer is moved relative to the workpiece. In other words, the surface of the foamed layer has a good characteristic of following the surface of the workpiece. Since the Shore D hardness of the foamed layer is in the range of 20 degrees or more and 30 degrees or less, that is, since its hardness is sufficiently low, unwanted protrusions formed on the surface of the workpiece and foreign objects and dirt attached to the surface of the workpiece can be easily removed.

### BRIEF DESCRIPTION OF THE DRAWINGS

FIG. 1 is a sectional view of a cleaning sheet embodying this invention.

FIG. 2 is a computer-generated image of the surface of the foamed layer of a cleaning sheet of this invention obtained by a scanning electron microscope (SEM).

FIG. 3 is a schematic side view of a portion of a double-surface cleaning device for carrying out the present invention.

### DETAILED DESCRIPTION OF THE INVENTION

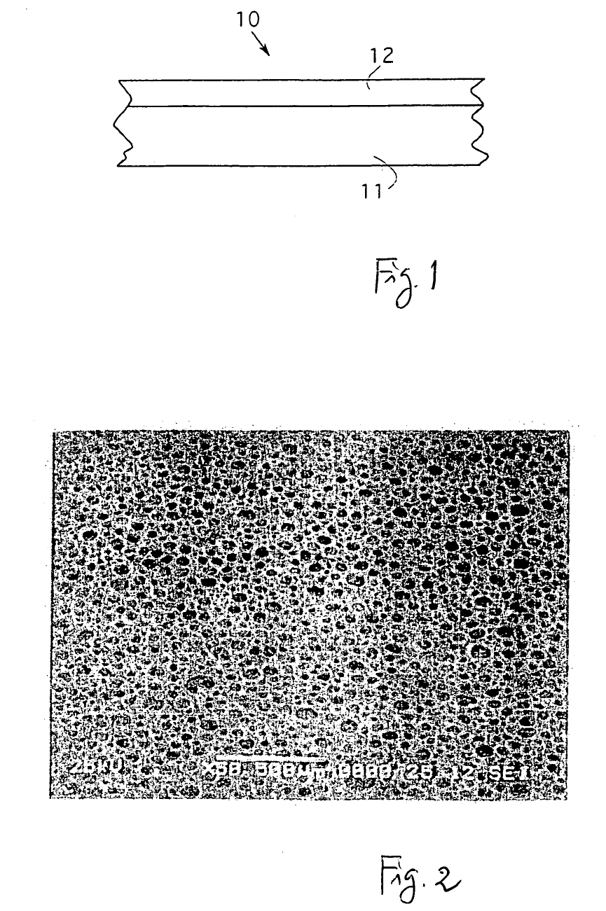

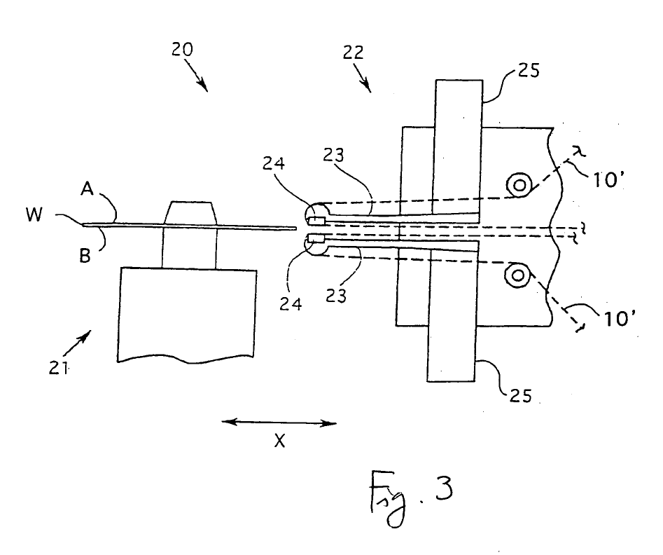

FIG. 1 shows a cleaning sheet 10 embodying this invention, comprising a base material 11 in a sheet-form and a foamed layer 12 that is formed on the surface of the base material 11. A computer-generated image of the surface of the foamed layer 12 obtained by a scanning electron microscope (SEM) is shown in FIG. 2.

The thickness of the base material is within the range of 25 μm or more and 125 μm or less. A plastic sheet with a flat and smooth surface and having a uniform thickness is used as the base material 11. A sheet of a synthetic resin material such as polyester and polyethylene terephthalate (PET) is used as the plastic sheet. The average diameter of the air bubbles inside the foamed layer 12 is within the range of 1 μm or more and 50 μm or less, and preferably within the range of 1 μm or more and 30 μm or less.

Since the finishing and cleaning processes of a workpiece are carried out by a so-called wet method (by supplying a cleaning liquid such as water between the surface of the foamed layer 12 and the surface of the workpiece), the lubricity of such cleaning liquid inside the foamed layer 12 and between the surface of the foamed layer and the surface of the workpiece becomes low if the average diameter of the air bubbles of the foamed layer 12 is less than 1 μm such that it becomes difficult to cause the foreign objects removed from the surface of the workpiece to be efficiently taken into the interior of the foamed layer 12. On the other hand, if the average diameter of the air bubbles of the foamed layer 12 exceeds 50 μm, the surface portion of the foamed layer 12 acting on unit area on the surface of the workpiece (exclusive of the portions corresponding to air bubbles) becomes small. Thus, not only does the time required for the finishing or cleaning of the surface of the workpiece become long, but also the lubricity of the cleaning liquid inside the foamed layer 12 and between the surface of the foamed layer and the surface of the workpiece becomes too high. As a result, the foreign objects, removed from the surface of the workpiece and once taken into the foamed layer 12, are again discharged out of the foamed layer 12 and scrape the surface of the workpiece excessively or form scratches on the surface of the workpiece.

According to this invention, the compressibility of the formed layer 12 is within the range of 3% or more and 7% or less, the compressibility being defined as the percentage of change in the thickness of the foamed layer 12 when a load of 16 psi is applied with respect to the thickness when the load is 1.4 psi under the temperature condition of 23±3° C.

The surface of the foamed layer 12 is compressed as it is pressed to the surface of the workpiece. If the compressibility of the foamed layer 12 is less than 3%, it becomes difficult for the surface of the foamed layer 12 to become compressed so as to follow the shape of the surface of the workpiece such that the compressive pressure of the foamed layer 12 (or the portion thereof exclusive of the portions of the air bubbles) on the surface of the workpiece becomes non-uniform and spots are formed on the finished or cleaned surface of the workpiece. If the compressibility of the foamed layer 12 exceeds 7%, on the other hand, the foamed layer 12 becomes too thin when it is pressed against the surface of the workpiece and the volume available for taking in a liquid such as the cleaning liquid becomes too small. As a result, it becomes difficult to efficiently cause the foreign objects scraped off from the surface of the workpiece to be taken into the interior of the foamed layer 12.

According to this invention, the compression recovery ratio of the foamed layer 12 is within the range of 40% or more and 60% or less, the compression recovery ratio being calculated by measuring the displacement of the foamed layer 12 when the load thereon is 16 psi under the temperature condition of 23±3° C. measuring the recovered displacement of the foamed layer 12 in 30 seconds after the load is reduced to 1.6 psi and dividing the recovered displacement by the displacement at the load of 16 psi (or the percentage ratio of the recovered displacement with respect to the displacement when compressed).

If the compression recovery ratio of the foamed layer 12 is less than 40%, the recovery force of its thickness is too low and the compressive force of the surface portion of the foamed layer 12 (exclusive of the portions of the air bubbles) onto the surface of the workpiece becomes low and the ability to remove the foreign objects attached to the surface of the workpiece becomes low. If the compression recovery ratio of the foamed layer 12 exceeds 60%, on the other hand, the recovery force is too strong and the compressive force of the foamed layer 12 (exclusive of the portions of the air bubbles) onto the surface of the workpiece becomes too high. As a result, when the foreign objects scraped off the surface of the workpiece are pressed against the surface of the workpiece, scratches come to be formed on the surface of the workpiece.

According to this invention, the Shore D hardness of the foamed layer 12 is within the range of 20 degrees or more and 30 degrees or less, the Shore D hardness being the measured value under the temperature condition of 23±3° C. by a shore D meter based on JIS-L-1096.

If the Shore D hardness of the foamed layer 12 is less than 20 degrees, the force of removing the foreign objects attached to the surface of the workpiece and the unwanted (abnormal) protrusions formed on the surface of the workpiece becomes weak. If the Shore D hardness of the foamed layer 12 exceeds 30 degrees, on the other hand, it becomes a problem that not only the unwanted (abnormal) protrusions formed on the surface of the workpiece but also the protruding portions of the textured marks formed on the surface of the workpiece are scraped off. Scratches also become easier to be formed on the surface of the workpiece.

The thickness of the foamed layer 12 is within the range of 50 μm or more and 800 μm or less.

If the foamed layer 12 is too thin, lubricity of liquid such as a cleaning liquid cannot be maintained at a high level for a long time inside the foamed layer 12 or between the surface of the foamed layer 12 and the surface of the workpiece and foreign objects cannot be caused to be taken into the foamed layer 12 efficiently for a long time. If the foamed layer 12 is too thick, on the other hand, spots are formed as foreign objects attached to the surface of the workpiece and dirt are removed. It may be because the foamed layer 12 deforms significantly in the direction along its surface during the finishing or cleaning process of the surface of the workpiece and the geometrical structure of the foamed layer 12 itself undergoes a significant change.

The cleaning sheet 10 as described above may be produced as follows. First, a resin solution is stirred mechanically to produce a paint having dispersed therein air bubbles with average diameter within the range of 1 μm or more and 50 μm or less (or preferably 1 μm or more and 30 μm or less) and having foaming magnification ratio within the range of 2× or more and 5× or less.

The resin solution contains urethane resin or acryl resin. Preferably the resin solution is one that contains self-emulsifying waterborne urethane resin. The use of self-emulsifying aqueous urethane resin makes it unnecessary to use particles such as aluminum hydroxide powder having functions of abrading particles as an external emulsifier. In other words, it becomes unnecessary to use as an external emulsifier any hard particles that may become one of the causes of scraping the surface of the workpiece excessively.

This resin solution may contain an agent adapted to accelerate its foaming and disperse air bubbles stably inside the paint. Such an agent may be selected from higher aliphatic acids, denaturations of higher aliphatic acids and alkali salts of higher aliphatic acids. Such an agent is contained by the resin solution preferably at a rate of 30 weight parts or less and more preferably 20 weight parts or less as solid component for 100 weight parts of the solid component of the resin solution. Even if more than 30 weight parts are contained as solid component for 100 weight parts of the solid component of the resin solution, however, there is no significant change in the function of accelerating the foaming of the resin solution or dispersing air bubbles stably inside the paint. As a preferred example, higher aliphatic acid ammonium is used as this agent.

For mechanically stirring the resin solution, the resin solution is placed inside a container and stirring vanes are caused to rotate therein. A high-pressure continuous foaming machine used for continuously mixing fresh cream, etc. (such as TM-70 (trade name) produced by Aiko-sha Seisakusho) may be used for this purpose. The size of the air bubbles dispersed in the paint and the foaming magnification can be adjusted by appropriately setting the rotational speed of the stirring vanes, the quantities of the resin solution and air, and the time of stirring.

Next, the paint thus produced is applied to the surface of the base material 11 to form a membrane on the surface of the base material 11. Any of the known technologies for the application of paint may be used such as the blade method, the gravier roll method, the knife method, the extrusion method, the reverse roll method and the case method.

Next, this painted membrane is dried to form on the surface of the base material the foamed layer 12 with average diameter of air bubbles within the range of 1 μm or more and 50 μm or less, the compressibility within the range of 3% or more and 7% or less, the compression recovery ratio within the range of 40% or more and 60% or less and the Shore D hardness within the range of 20 degrees or more and 30 degrees or less.

The painted membrane is dried within an environment of 90° C.-160° C. In order to completely harden the membrane, a far infra-red ray may be employed.

The cleaning sheet 10 according to this invention is thus produced.

The cleaning sheet 10 of this invention is cut into a convenience size so as to be easily usable for cleaning the surface of a workpiece as a cleaning tool such as a cleaning tape or a cleaning pad.

For cleaning the surface of a workpiece, a cleaning liquid is supplied to the surface of the workpiece and the workpiece and the cleaning tool are moved relative to each other while the cleaning tool is pressed onto the surface of the workpiece. The cleaning liquid functions also as a coolant and a lubricant. Water (or pure water) may conveniently be used as the cleaning liquid.

In order to finish or clean the surface of a workpiece chemically and mechanically, a reaction liquid capable of chemically reacting with the surface of the workpiece may be contained by the cleaning liquid according to this invention. If such a reaction liquid is used for the finishing or cleaning, water (or pure water) is used thereafter to rinse the workpiece. A cleaning sheet of this invention is used for the rinsing.

The reaction liquid is conveniently selected according to the material comprising the surface of the workpiece. If the material that comprises the surface of the workpiece is silicon dioxide, potassium hydroxide, tetramethyl ammonium hydroxide, fluoric acid and fluorides may be used. If the surface of the workpiece is tungsten, iron nitrate and potassium iodate may be used. If the surface of the workpiece is copper, glycine, quinaldinic acid, hydrogen peroxide and benzotriazol may be used.

FIG. 3 shows an example of cleaning device 20 adapted to clean both surfaces of a disk-shaped workpiece W simultaneously (as disclosed in Japanese Patent Publication Tokkai 2001-162504). FIG. 3 shows a cleaning sheet of this invention in the cut form of a cleaning tape 10′. As shown, the cleaning device 20 comprises a cleaning head 22 for cleaning both surfaces of the workpiece W and a means (not shown) for causing the cleaning head 22 to move reciprocatingly in the direction (shown by arrow X) of the workpiece W attached to a spindle 21. The cleaning head 22 has a pair of arms 23 which are set so as to face each other and elastic rubber pads 24 are affixed to the tips of these arms 23.

For cleaning both surfaces (indicated as A and B) of the workpiece W, the workpiece W attached to the spindle 21 is rotated, while each cleaning tape 10′ is advanced onto the corresponding one of the pads 24, pressing means 25 is driven so as to press the cleaning tapes 10′ through the pads 24 onto both surfaces A and B of the workpiece W and to move them reciprocatingly in the radial direction of the workpiece W as shown by arrow X. During this cleaning operation, the cleaning tapes 10′ may be advanced either continuously or intermittently, or may not be advanced at all.

Although not shown separately, the cleaning sheet 10 may be cut and used as a cleaning pad. After such a pad is pasted onto the surface of a lapping plate, this lapping plate is rotated while a cleaning liquid is supplied to the surface of the cleaning pad and the surface of the workpiece is pressed onto the surface of the cleaning pad.

Next, the invention is described by way of Test Example and Comparison Example.

As Test Example, a cleaning sheet according to this invention was produced as follows. First, a resin solution containing self-emulsifying waterbome polyurethane dispersion was prepared. In order to accelerate the foaming of this resin solution and to disperse air bubbles in a stable manner inside a paint when this resin solution was prepared, an adjuster of form formation and an adjuster of bubble size and shape were added to this self-emulsifying waterbome polyurethane dispersion. The composition of this resin solution is shown in Table 1. The solid content of the self-emulsifying waterborne polyurethane dispersion was 40%.

TABLE 1

| | |
|---|---|
| Waterborne polyurethane dispersion | 90 weight parts |
| (self-emulsifying type): | |
| Product name: Superflex 410 | |
| Produced by: Daiichi Kogyo Seiyaku Kabushiki Kaisha | |
| Adjuster of foam formation: | 4 weight parts |
| N-beef fat alkylsulpho-succinanamate/sodium sulfite | |
| Product name: FCU-305 | |
| Produced by: Sanko Kagaku Kogyo Kabushiki Kaisha | |
| Adjuster of bubble size and shape: | 7 weight parts |
| Higher aliphatic ammonium | |
| Product name: DC-100A | |
| Produced by: Sannopco Kabushiki Kaisha | |

Next, this resin solution was stirred by using a known type of continuous foaming device (with the rotational speed of the rotary vanes=2000 rpm) to produce a paint with foaming magnification 3× and having air bubbles of average diameter 30 μm dispersed.

Next, this paint was applied to the surface of a PET sheet of thickness 50 μm by using a cylindrical blade coater of a known kind to form a membrane comprising this paint on the surface of this sheet. This membrane was completely dried in an environment of 100° C. to form a foaming layer of thickness 400 μm on the surface of the PET sheet to produce a cleaning sheet of this invention (Test Example). Mechanical characteristics of this cleaning sheet of Test Example are summarized in Table 3.

As Comparison Example, another cleaning sheet was produced as follows. First, a resin solution containing waterbome polyurethane dispersion was prepared. In order to accelerate the foaming of this resin solution and to disperse air bubbles in a stable manner inside a paint when this resin solution was prepared, a foaming agent, an adjuster of compressibility and elasticity, a cross-linking agent, a hardening agent and a thickener were added to this waterbome polyurethane dispersion. The composition of this resin solution is shown in Table 2.

TABLE 2

| | | |
|---|---|---|
| Waterborne polyurethane dispersion: | 28 | kg |
| Product name: DICFORM F-505EL | | |
| Produced by: Dainippon Ink and Chemicals, Inc. | | |
| Foaming agent: | 8.7 | kg |
| Product name: F-1 | | |
| Produced by: Dainippon Ink and Chemicals, Inc. | | |
| Adjuster of compressibility and elasticity: | 0.29 | kg |
| Product name: NBA-1 | | |
| Produced by: Dainippon Ink and Chemicals, Inc. | | |
| Cross linking agent: | 0.58 | kg |
| Product name: CATALYST/PA-20 | | |
| Produced by: Dainippon Ink and Chemicals, Inc. | | |
| Hardening agent: | 0.87 | kg |
| Product name: DR-5L | | |
| Produced by: Dainippon Ink and Chemicals, Inc. | | |
| Thickener: | 1.45 | kg |
| Product name: VONCOAT 3750me: | | |
| Produced by: Dainippon Ink and Chemicals, Inc. | | |

Next, this resin solution was stirred similarly as in Test Example by using a known type of continuous foaming device (with the rotational speed of the rotary vanes=2000 rpm) to produce a paint with foaming magnification 3× and having air bubbles of average diameter 110 μm dispersed.

Next, this paint was applied to the surface of a PET sheet of thickness 50 μm by using a cylindrical blade coater of a known kind to form a membrane comprising this paint on the surface of this sheet. This membrane was completely dried in an environment of 100° C. to form a foaming layer of thickness 400 μm on the surface of the PET sheet to produce a cleaning sheet (Comparison Example). Mechanical characteristics of this cleaning sheet of Comparison Example are summarized in Table 3.

TABLE 3

| | Test Example | | Comparison Example | |
|---|---|---|---|---|
| Average diameter of air bubbles | 30 | μm | 110 | μm |
| Compressibility | 5% | | 4% | |
| Compression Recovery Ratio | 45.8% | | 20% | |
| Shore D Hardness | 26 | degrees | 55 | degrees |

These cleaning sheets (Test Example and Comparison Example) were each cut and used to clean both surfaces of a magnetic hard disk, and the surface conditions before and after the cleaning process were compared. The magnetic hard disks to be used for this comparison test were prepared first by mirror-polishing the surfaces of glass substrates and then forming a magnetic layer and a protective layer on each surface thereafter. One such disk each for Test Example and Comparison Example was prepared.

The cleaning of the surfaces (both Surface A and Surface B) of the magnetic hard disks was carried out under the conditions shown in Table 4. Pure water was used as the cleaning liquid.

TABLE 4

| | |
|---|---|
| Rotational speed of substrate | 1000 rpm |
| Compressive pressure of tape | 40 gf |
| Hardness of rubber pads | 25 duro |
| Supply speed of tape | Stopped while the tapes were |
| | pressed to the substrate |
| Operating time | 10 seconds |
| Direction of head | Moving from outer periphery |
| | to inner periphery of substrate |
| | and through to outer periphery |

The numbers of foreign objects (particles), abnormal protrusions and scratches on the magnetic hard disks before and after the cleaning were measured by using an optical surface analyzer (OSA5100 (trade name) produced by Candela Instruments, Inc.) while laser light was made incident on the magnetic hard disk rotating at 10000 rpm. The average surface roughness (Ra) and the maximum protrusion height (Rmax) were measured by using a white-light microscope (New View 5020 (trade name) produced by Zygo, Inc.) within an arbitrarily selected area of size 0.87 mm×0.87 mm. The results of the comparison test are shown in Tables 5 and 6.

TABLE 5

| | Test Example | | | |
|---|---|---|---|---|
| | Before cleaning | | After cleaning | |
| | Surface A | Surface B | Surface A | Surface B |
| Foreign objects and | Over 300 | Over 300 | 6 | 5 |
| abnormal protrusions | | | | |
| Scratches | 20 | 14 | 7 | 4 |
| Average surface | 17.2 Å | 20.3 Å | 6.9 Å | 7.2 Å |
| roughness (Ra) | | | | |
| Maximum protrusion | 271.2 Å | 265.4 Å | 104.5 Å | 98.3 Å |
| height (Rmax) | | | | |

TABLE 6

| | Comparison Example | | | |
|---|---|---|---|---|
| | Before cleaning | | After cleaning | |
| | Surface A | Surface B | Surface A | Surface B |
| Foreign objects and | Over 300 | Over 300 | 15 | 9 |
| abnormal protrusions | | | | |
| Scratches | 15 | 21 | 21 | 26 |
| Average surface | 18.9 Å | 17.4 Å | 12.9 Å | 17.4 Å |
| roughness (Ra) | | | | |
| Maximum protrusion | 259.2 Å | 232.5 Å | 90.5 Å | 108.3 Å |
| height (Rmax) | | | | |

Tables 5 and 6 show that foreign objects and abnormal protrusions can be eliminated better, the surface roughness can be reduced more and scratches can be significantly reduced according to the present invention.

What is claimed is:

1. A cleaning sheet comprising:
a base material formed as a sheet; and
a foamed layer formed on a surface of said base material;
wherein the average diameter of air bubbles in said foamed layer is in the range of 1 μm or more and 50 μm or less, the compressibility of said foamed layer is in the range of 3% or more and 7% or less, the compression recovery ratio of said foamed layer is in the range of 40% or more and 60% or less, and the Shore D hardness of said foamed layer is in the range of 20 degrees or more and 30 degrees or less.

2. The cleaning sheet of claim 1 wherein the average diameter of air bubbles in said foamed layer is in the range of 1 μm or more and 30 μm or less.

3. The cleaning sheet of claim 1 wherein said foamed layer comprises polyurethane resin.

4. A method of producing a cleaning sheet, said method comprising the steps of:
stirring a resin solution mechanically to thereby obtain a paint having dispersed therein air bubbles with average diameter in the range of 0.5 μm or more and 50 μm or less, said paint having the expansion ratio in the range of 2× or more and 5× or less;
coating a surface of a base material formed as a sheet with said paint to thereby form a membrane comprising said paint on the surface of said base material; and
drying said membrane to thereby form a foamed layer on the surface of said base material;
wherein the average diameter of air bubbles in said foamed layer is in the range of 1 μm or more and 50 μm or less, the compressibility of said foamed layer is in the range of 3% or more and 7% or less, the compression recovery ratio of said foamed layer is in the range of 40% or more and 60% or less, and the Shore D hardness of said foamed layer is in the range of 20 degrees or more and 30 degrees or less.

5. The method of claim 4 wherein the average diameter of air bubbles in said foamed layer is in the range of 1 μm or more and 30 μm or less.

6. The method of claim 4 wherein said resin solution contains self-emulsifying waterbome urethane resin.

7. The method of claim 6 wherein said resin solution further contains an agent that accelerates the foaming of said resin solution and disperses air bubbles stably inside said paint, said agent being selected from the group consisting of higher fatty acids, denaturations of higher aliphatic acids and alkali salts of higher aliphatic acids.

8. The method of claim 7 wherein said agent is higher fatty acid ammonium.
